(19) United States
(12) Patent Application Publication
(10) Pub. No.: US 2003/0107892 A1
(43) Pub. Date: Jun. 12, 2003

(54) Lamp reflecting apparatus used in direct under type backlight module

(75) Inventor: Cheng-Hung Yao, Tainan County (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Chi Mei Optoelectronics Corp.

(21) Appl. No.: 10/125,209

(22) Filed: Apr. 17, 2002

(30) Foreign Application Priority Data
Dec. 12, 2001 (TW) 90130785

(51) Int. Cl. F21V 7/00

(52) U.S. Cl. 362/255; 362/311; 362/346

(57) ABSTRACT

The present invention relates to a lamp reflecting apparatus for use in a direct under type backlight module, wherein the backlight module comprising a plurality of lamps, a diffusing plate and a bottom reflecting plate. The diffusing plate is located above the lamps while the bottom reflecting plate is deposited under the lamps. The lamp reflecting apparatus provided between the lamps and diffusing plate comprises a reflecting layer for use in reflecting light emitted from the lamps to the bottom reflecting plates. Light non-uniformity resulting from light directly emitted to the diffusing plate directly above the lamps and the thickness of the backlight module can be reduced. Besides, light efficiency is also increased. The present invention can be applied in different backlight modules by changing shapes and sizes of the light reflecting apparatus.

### BACKGROUND OF THE INVENTION

1. Field of the Invention

The present invention relates to a direct under type backlight module, more particularly, to a lamp reflecting apparatus used in a direct under type backlight module of liquid crystal display device.

2. Description of the Related Art

Liquid crystal display devices have been applied much in personal computers, laptop computers and various communication equipments. They take advantage of a plurality of polarized liquid crystal panels which can form images according to additional electric fields to show specific data. However, liquid crystal absorbs but not emits light; thus, a backlight module must be applied as a light source to provide liquid crystal display devices.

Many kinds of backlight modules are applied in liquid crystal display devices in this field. A typical direct under type backlight module 1 (shown in FIG. 1), which is placed under a liquid crystal panel in the liquid crystal display device, comprises a plurality of lamps 11, a diffusing plate 12, a bottom reflecting plate 13, and two lateral reflecting plates 14. The lamps 11 which can be fluorescent lamps are used in providing light source. The diffusing plate 12 used in diffusing light emitted from the lamps 11 to the liquid crystal panel is placed above the lamps 11, and the material of the diffusing plate 12 is usually polymethymetharylate (PMMA) or polycarbonate (PC). The bottom reflecting plate 13, which is made of reflecting polycarbonate or polyethylene terephthalate (PET), is deposited under the lamps 11 for used in reflecting bottom light source emitted from the backlight module 1 to the diffusing plate 12. Besides, the lateral reflecting plates 14, which are also made of reflecting polycarbonate or polyethylene terephthalate, are provided at opposite lateral sides for used in reflecting lateral light source emitted from the backlight module 1 to the diffusing plate 12.

Referring to FIG. 1, because the lamps 11 are deposited directly under the diffusing plate 12, the brightness is high in the direct under type backlight module 1. Furthermore, the weight is lighter than other types of backlight module by its simple structure. In addition, when users look at the liquid crystal display device, they will feel view angles larger because there are no shelters above the diffusing plate 12 in the direct under type backlight module 1. On the other hand, regions directly above the lamps 11 are brighter because light emits directly to the diffusing plate 12 while regions between the lamps are darker. Thus, the brightness is not uniform. Besides, enough space should be kept between the lamps 11 and the diffusing plate 12 in the direct under type backlight module 1 to avoid being over bright in view of the lamps 11 emit light to the diffusing plate 12 directly. Therefore, compared with other types of backlight module, the direct under type is thicker.

In order to resolve such problems, embedding lamps into the polycarbonate reflecting plate to improve light uniformity was enclosed in Japan Patent Publication No. 05-323312; however, the thickness cannot be reduced either. A prism board is provided between lamps and a diffusing plate has been suggested in Japan Patent Publication No. 05-333333 which takes an advantage of the refraction by a series of prisms to make light emitted from the lamps in different directions inject uniformly into the diffusing plate, but the thickness is still not reduced by the additional prism board. Besides, a backlight module 2 in FIG. 2 has been enclosed in Japan Patent Publication No. 2000-338895, which comprises a plurality of lamps 21, a diffusing plate 22, a bottom reflecting plate 23, two lateral reflecting plates 24, and a plurality of lenses 25 deposited between each one of the lamp 21 and diffusing plate 22. The lenses 25 can be convex lenses for use in focusing light emitted from the lamps 21, or they can be concave lenses for dispersing the light. Both of the convex and concave lenses can make the light inject into the diffusing plate 22 evenly, but the thickness of the backlight module 2 still cannot be efficiently reduced.

Therefore, developing a novel and improved backlight module to attain light uniformity but not increase the thickness remains to be established in this field.

### SUMMARY OF THE INVENTION

One objective of the present invention is to provide a lamp reflecting apparatus for use in a direct under type backlight module, wherein the backlight module comprising a plurality of lamps, a diffusing plate and a bottom reflecting plate. The diffusing plate is located above the lamps while the bottom reflecting plate is deposited under the lamps. The lamp reflecting apparatus provided between the lamps and diffusing plate comprises a reflecting layer for use in reflecting light emitted from the lamps to the bottom reflecting plates. Light non-uniformity resulting from light directly emitted to the diffusing plate directly above the lamps and the thickness of the backlight module can be reduced. Besides, light efficiency is also increased. The present invention can be applied in different backlight modules by changing shapes and sizes of the light reflecting apparatus.

### BRIEF DESCRIPTION OF THE DRAWINGS

FIG. 1 is a cross-sectional view illustrating the conventional direct under type backlight module;

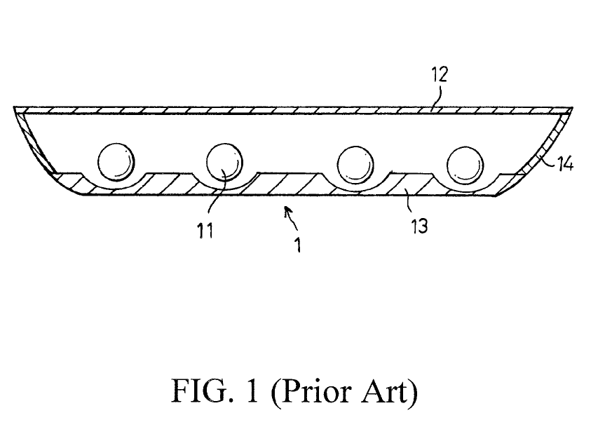

FIG. 2 is a cross-sectional view illustrating the conventional direct under type backlight module;

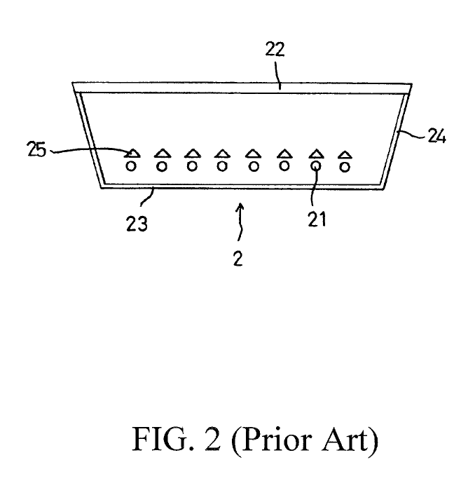

FIG. 3 is a cross-sectional view illustrating the direct under type backlight module according to the first embodiment of the invention;

FIG. 4 is a cross-sectional view illustrating the direct under type backlight module according to the second embodiment of the invention;

FIG. 5 is a cross-sectional view illustrating the direct under type backlight module according to the third embodiment of the invention;

FIG. 6 is a cross-sectional view illustrating the direct under type backlight module according to the fourth embodiment of the invention;

FIG. 7 is a cross-sectional view illustrating the direct under type backlight module according to the fifth embodiment of the invention; and

FIG. 8 illustrates the direct under type backlight module according to the third embodiment of the invention.

### DETAILED DESCRIPTION OF THE INVENTION

The preferred embodiments in the invention are described below.

The First Embodiment

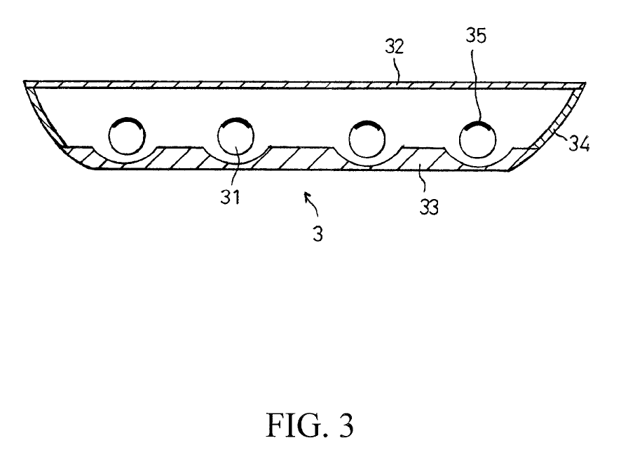

Referring to FIG. 3, a direct under type backlight module 3 comprises a plurality of lamps 31, a diffusing plate 32, a reflecting plate 33, and two lateral reflecting plates 34. Each of the lamps 31 is used in providing the backlight module 3 light source and comprises a reflecting layer 35 on an inner surface, and the diffusing plate 32 is located above the lamps 31 for use in diffusing light source. Besides, the bottom reflecting plate 33 is provided under the lamps 31 while the lateral reflecting plates 34 are provided at each lateral side of the backlight module 3 for use in reflecting light emitted from the lamps 31 to the diffusing plate 32.

The present invention is characterized in designs of the reflecting layer 35 located on an upper part of an inner surface of the lamp, and it can change light emitted upwards to downwards. Light emitted from the lamps 31 is first reflected to the bottom reflecting plate 33 or lateral plates 34 and then to the diffusing plate 32 by the reflecting layer 35. Therefore, darkness will not appear in a region of the diffusing plate 32 directly above the reflecting layer 35 and such a region is as bright as others because light will be reflected to it to increase light uniformity.

The Second Embodiment

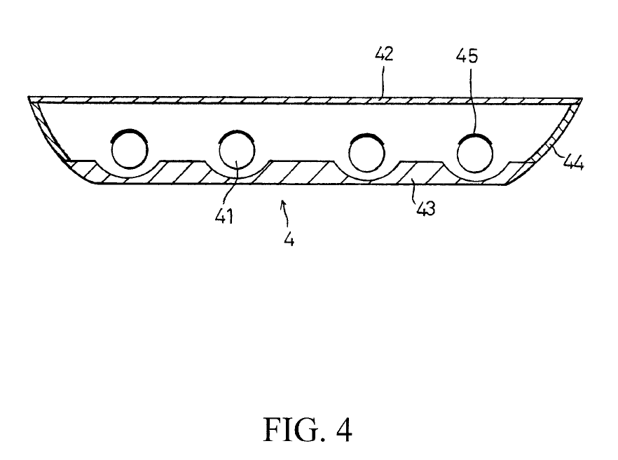

Referring to FIG. 4, a direct under type backlight module 4 comprises a plurality of lamps 41, a diffusing plate 42, a reflecting plate 43, and two lateral reflecting plates 44. Each of the lamps 41 is used in providing the backlight module 4 light source and comprises a reflecting layer 45 on an upper part of an outer surface. The reflecting layer 45 is used in reflecting light emitted from the lamps 41 to the reflecting plate 43 first and then to the diffusing plate 42.

The Third Embodiment

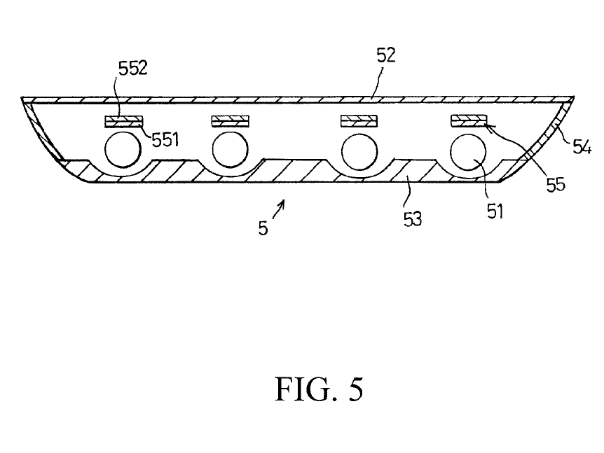

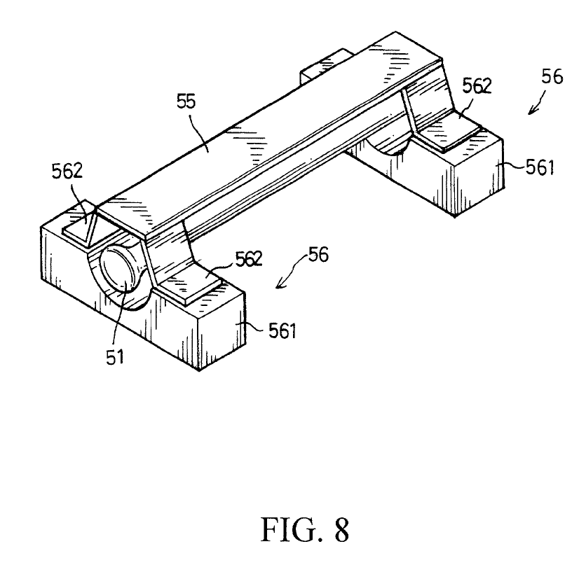

Referring to FIGS. 5 and 8, a direct under type backlight module 5 comprises a plurality of lamps 51, a diffusing plate 52, a reflecting plate 53, two lateral reflecting plates 54, a plurality of lamp reflecting covers 55, and a plurality of fixing assemblies, wherein the lamps 51 used in providing the backlight module 5 light source, and the diffusing plate 52 located above the lamps 51 for use in diffusing light source, and the bottom reflecting plate 53 deposited under the lamps 51 while the lateral reflecting plates 54 deposited at each lateral sides of the backlight module 5 for use in reflecting lateral light emitted from the lamps 51 to the diffusing plate 52. Besides, The lamp reflecting covers 55 located between each of the lamps 51 and diffusing plate 52 cover each lamp 51.

Referring to FIG. 8, each of the fixing assemblies comprises two fixing devices 56 located at both ends of the lamps 51, wherein each of the fixing structures 56 comprising two fixing stands 561 and two fixing elements 562, wherein the fixing stands 561 combining with the fixing elements 562 located at two ends of the lamps 51 and lamp reflecting covers 55 for use in fixing the lamps 51 and lamp reflecting covers 55. The fixing stands 561 can stand alone or be connected to the adjacent fixing stands or provided by other frames or chassis of the backlight module 5 or a liquid crystal display device.

In the embodiment, each of the lamp reflecting covers 55 comprises a reflecting layer 551 and a light impassable layer 552. The reflecting layer 551 is located on a bottom surface of the lamp reflecting cover 55 facing to to the lamp 51; wherein the bottom surface is planer and can change light emitted upwards from the lamps 51 to downwards and thus reflect light to the bottom or lateral reflecting plates 52 and 54 and further to the diffusing plate 52. The light impassable layer 552 is located on a top surface facing to the diffusing plate 52. The light is reflected by the bottom and lateral reflecting plates 53 and 54 to regions sheltered by the lamp reflecting covers 55. Therefore, the darkness will not appear in such region of the diffusing plate 52 sheltered by the lamp reflecting covers 55, and brightness is as uniform as in other regions.

The Forth Embodiment

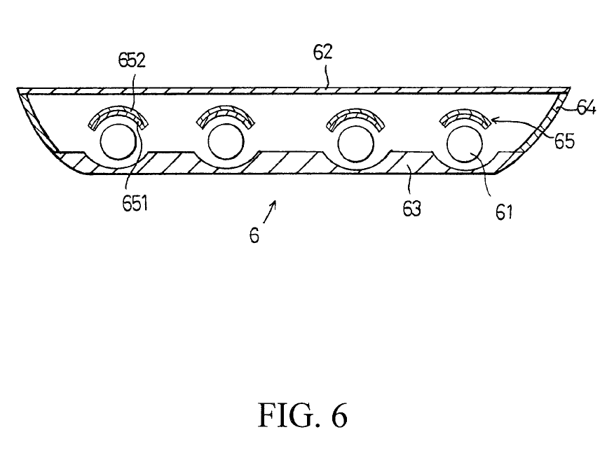

Referring to FIG. 6, a direct under type backlight module 6 which is similar to the backlight module 5 comprises a plurality of lamps 61, a diffusing plate 62, a reflecting plate 63, two lateral reflecting plates 64, a plurality of lamp reflecting covers 65, and a plurality of fixing assemblies (not shown). Each of the lamp reflecting covers 65 covering each lamp 61 above comprises a reflecting layer 651 located on a bottom surface facing the lamp 61 when a light impassable layer 652 located on a top surface facing the diffusing plate 62. The lamp reflecting cover 65 is convex which can focus light emitted upwards from the lamp 61 to the reflecting plate 63 and then reflect to the diffusing plate 62.

The Fifth Embodiment

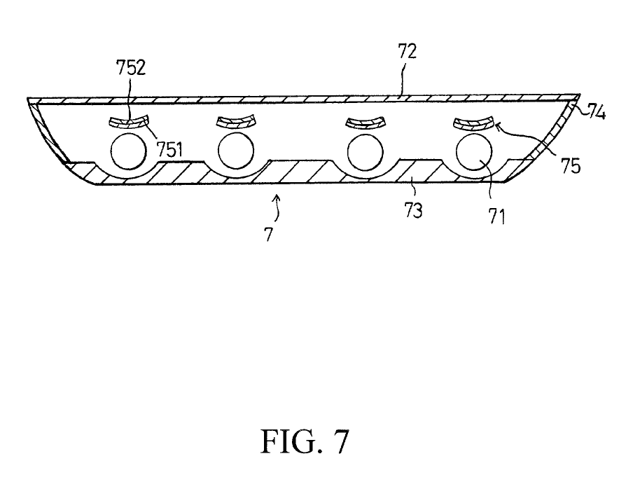

Referring to FIG. 7, a direct under type backlight module 7 which is similar to the backlight module 5 comprises a plurality of lamps 71, a diffusing plate 72, a reflecting plate 73, two lateral reflecting plates 74, a plurality of lamp reflecting covers 75, and a plurality of fixing assemblies (not shown). Each one of the lamp reflecting covers 75 covering each lamp 71 above comprises a reflecting layer 751 located on a bottom surface facing the lamp 71 when a light impassable layer 752 located on a top surface facing the diffusing plate 72. The lamp reflecting cover 75 is concave which can strengthen light emitted upwards from the lamp 71 to the reflecting plate 73 and then reflect to the diffusing plate 72.

The advantages of the invention are increasing light uniformity of the direct under type backlight module by changing a direction of light emitted from the lamps, avoiding light directly above the lamps from emitting to the diffusing plate directly to be over bright, raising light efficiency by reflection of the reflecting apparatus, and lowering thickness of the backlight module by absenting a distance kept between the lamps and the diffusing plate because light is not emitted upwards to the diffusing plate directly. In addition, the reflecting apparatus provides a reflecting layer or a reflecting cover suitable for different designs of backlight module.

For example, the reflecting apparatus can be in different forms and sizes according to numbers and locations of lamps, shapes of diffusing and reflecting plates, and thickness of backlight module.

The present invention can be applied in all kinds of direct under type backlight module in a liquid crystal display device. Shapes and sizes of reflecting apparatus are not limited to the disclosures of the embodiments mentioned above. The backlight modules, which can change light emitted upwards to downwards, are in the scope of the invention.

While embodiments of the present invention have been illustrated and described, various modifications and improvements can be made by persons skilled in the art. The embodiments of the present invention are therefore described in an illustrative but not restrictive sense. It is intended that the present invention is not limited to the particular forms as illustrated, and that all the modifications not departing from the spirit and scope of the present invention are within the scope as defined in the appended claims.

What is claimed is:

1. A lamp reflecting apparatus for use in a direct under type backlight module; the backlight module comprising a plurality of lamps, a diffusing plate disposed above the lamps, and a reflecting plate disposed under the lamps; wherein the lamp reflecting apparatus is located between the lamps and the diffusing plate, and comprises:
a plurality of reflecting layers provided to reflect part of light emitted from the lamps to the reflecting plate.

2. A lamp reflecting apparatus according to claim 1, wherein each of the reflecting layers is provided on an upper part of an inner surface of each of the lamps.

3. A lamp reflecting apparatus according to claim 1, wherein each of the reflecting layers is provided on an upper part of an outer surface of each of the lamps.

4. A lamp reflecting apparatus according to claim 1 further comprising a plurality of lamp reflecting covers located above the lamps to cover each of the lamps.

5. A lamp reflecting apparatus according to claim 4, wherein each of the reflecting layers is located on a surface of each of the lamp reflecting covers.

6. A lamp reflecting apparatus according to claim 5, wherein each of the lamp reflecting covers is planer.

7. A lamp reflecting apparatus according to claim 5, wherein each of the lamp reflecting covers is curved.

8. A lamp reflecting apparatus according to claim 7, wherein each of the lamp reflecting covers is convex.

9. A lamp reflecting apparatus according to claim 7, wherein the lamp reflecting cover is concave.

10. A lamp reflecting apparatus according to claim 4, wherein the backlight module further comprises a plurality of fixing assemblies, each of which comprises two fixing devices located at both ends of each of the lamps for fixing each of the lamps and lamp reflecting covers.

11. A lamp reflecting apparatus according to claim 4, wherein the backlight module further comprises a plurality of fixing assemblies, each of which comprises a fixing stand and two fixing elements; wherein the two fixing elements extend from the fixing stand to both ends of the lamp reflecting cover for fixing each of the lamp reflecting covers to the fixing stand.

12. A lamp reflecting apparatus according to claim 1, wherein the backlight module further comprises two lateral reflecting plates located at two opposite sides of the backlight module respectively.
